(19) United States
(12) Patent Application Publication
(10) Pub. No.: US 2025/0115704 A1
(43) Pub. Date: Apr. 10, 2025

(54) FOAMABLE MULTI-COMPONENT COMPOSITION, AND FOAMED FIRE-PROTECTION PROFILE HAVING TEMPERATURE-REGULATING FILLERS

(71) Applicant: Hilti Aktiengesellschaft, Schaan (LI)

(72) Inventors: Laura Schwabbauer, Muenchen (DE); Christian Förg, Buchloe (DE); Mario Paetow, Landsberg am Lech (DE); Andreas Ober, Kaufering (DE); Björn Bambach, Landsberg/Lech (DE)

(73) Assignee: Hilti Aktiengesellschaft, Schaan (LI)

(21) Appl. No.: 18/729,215

(22) PCT Filed: Jan. 25, 2023
(86) PCT No.: PCT/EP2023/051773

§ 371 Date: Jul. 16, 2024

(30) Foreign Application Priority Data
Feb. 3, 2022 (EP) 22154963.7

(51) Int. Cl. C08G 18/66; C08G 18/32; C08G 18/48; C08G 18/76; C08K 3/04; C08K 3/22; C08K 3/26; C08K 3/30; C08K 7/26; C08K 11/00

(52) U.S. Cl. CPC C08G 18/6674; C08G 18/3206; C08G 18/4829; C08G 18/7671; C08K 3/04; C08K 3/22; C08K 3/26; C08K 3/30; C08K 7/26; C08K 11/005; C08G 2110/0083; C08K 2003/2227; C08K 2003/3045

(57) ABSTRACT

The present invention relates to a foamable multicomponent composition for producing foamed fire-protection profiles, and fire-protection profiles produced from the multi-component composition according to the invention. The foamable multi-component composition and the fire-protection profile comprise at least one temperature-regulating filler which improves the fire-resistance duration in the event of a fire. The present invention further relates to the use of temperature-regulating fillers for improving the fire-resistance duration of fire-protection profiles in the event of a fire, in particular fire-protection profiles having a low density.

The present invention relates to a foamable multicomponent composition for producing foamed fire-protection profiles, and fire-protection profiles produced from the multi-component composition according to the invention. The foamable multi-component composition and the fire-protection profile comprise at least one temperature-regulating filler which improves the fire-resistance duration in the event of a fire. The present invention further relates to the use of temperature-regulating fillers for improving the fire-resistance duration of fire-protection profiles in the event of fire, in particular fire-protection profiles having a low density.

When installing lines, such as pipelines, electrical cables and the like, they are guided through passage openings in components, in particular building components, such as walls and ceilings. In order to prevent the passage of fire and smoke gases in the event of a fire, fire-protection isolation materials, such as fire-protection pads and fire-protection bricks are introduced between the inner walls of the passage openings and the lines guided therethrough. These consist in many cases of polyurethane foams. However, other foams, for example based on epoxy amine, are also used.

In the patent specification WO2019/145175 A1, an assembly of a plurality of fire-protection profiles is described. The fire-protection profiles used to produce the assembly have a reduced density of 100 kg/m³ to 200 kg/m³ in the cured state. This has the particular advantage that the fire-protection profiles can be compressed at least slightly further, such that complicated cutting to size when sealing apertures can be omitted. However, a reduction in density can have a disadvantageous effect on the fire-resistance duration in the event of a fire. WO2019/145175 A1 therefore proposes the use of an inorganic fiber material and a film. The fire-protection profiles are designed in such a way that they bake together in the event of a fire.

However, there continues to be a need to combine the installation advantages resulting from low densities of the fire-protection profiles with an improved fire-resistance duration.

It is therefore an object of the present invention to provide a solution by means of which the fire-resistance duration of foamed fire-protection profiles in the event of a fire, in particular of foamed fire-protection profiles having a low density, can be reliably improved.

The object on which the invention is based was surprisingly able to be achieved by the use of temperature-regulating fillers in a foamable multicomponent composition. Temperature-regulating fillers within the meaning of the present invention denote those fillers which are capable of bringing about a “cooling effect” in the event of a fire. The cooling effect can be realized by “active cooling” or by “passive cooling”. Active cooling refers here to a controlled reduction of the temperature, for example caused by a chemical reaction. Passive cooling refers to an insulating effect. The use of temperature-regulating fillers in fire-protection profiles thus makes it possible, in the event of a fire, to delay or even prevent the heat transfer to the side facing away from the fire.

The invention furthermore relates, secondly, to a fire-protection profile produced from the foamable multi-component composition according to the invention.

The invention thirdly also relates to the use of at least one temperature-regulating filler in fire-protection profiles for improving the fire-resistance duration.

In order to better understand the invention, the following explanations of the terminology used herein are considered to be useful. Within the meaning of the invention:
“endothermic filters” denote those fillers which undergo an endothermic reaction when heat is introduced (such as in the event of a fire). An endothermic reaction is a chemical reaction in which energy is absorbed from the surroundings. The term “filler” is understood to mean organic and/or inorganic, preferably inorganic, compounds that increase the volume of the multi-component composition;
“thermal conductivity” is a material property and describes the ability of a material to transport thermal energy in the form of heat. The thermal conductivity is specified in the unit of measurement W m⁻¹K⁻¹.
“Multi-component composition” is a composition comprising a plurality of components stored separately from one another, such that a reaction of the individual components takes place only after all components have been mixed. In a preferred embodiment of the invention, the multi-component composition is a two-component composition which comprises two components stored separately from one another. The two-component composition comprises an isocyanate component (A) and a component (B) that is reactive with respect to isocyanate groups, such that a reaction of the isocyanate groups contained in the isocyanate component (A) takes place only after the mixing of the two components;
“isocyanates” are compounds that have a functional isocyanate group —N═C═O and are characterized by the structural unit R—N═C═O (where R is an organic group);
“polyisocyanates” are compounds that have at least two functional isocyanate groups —N═C═O; diisocyanates, which are also covered by the definition of polyisocyanate, are characterized, for example, by the structure O═C═N—R—N═C═O, where R represents any desired organic group;
“average NCO functionality” describes the number of isocyanate groups in the compound; in the case of a mixture of isocyanates, the “averaged NCO functionality” describes the averaged number of isocyanate groups in the mixture and is calculated according to the formula: averaged NCO functionality (mixture)=Σ average NCO functionality (isocyanate i)/nᵢ, i.e., the sum of the average NCO functionality of the individual components divided by the number of individual components;
“isocyanate component (A)”, or also A component, describes a component of the multi-component composition which comprises at least one polyisocyanate and optionally at least one filler and/or at least one rheology additive and/or further additives;
“amines” are compounds which have at least one functional NH group, are derived from ammonia by replacing one or two hydrogen atoms with hydrocarbon groups, and have the general structures RNH₂ (primary amines) and R₂NH (secondary amines) (see: IUPAC Compendium of Chemical Terminology, 2^{nd} ed. (the “Gold Book”), Compiled by A. D. McNaught and A. Wilkinson, Blackwell Scientific Publications. Oxford (1997));
“alcohols” denote organic compounds in which at least one hydroxyl group —OH is bound to a saturated carbon atom. “Polyols” are alcohols which have at least two functional hydroxyl groups —OH;
“NH functionality” or “OH functionality” of an amine or an alcohol describes the number of active hydrogen atoms which can react with an isocyanate group;
“average NH functionality” or “average OH functionality” describes the number of active hydrogen atoms of an amine or an alcohol which can react with an isocyanate group in an amine or in an alcohol. This results from the number and NH functionality or OH functionality of the amino groups or hydroxyl groups contained in the compound.
“Reactive component (B) reactive with respect to isocyanate groups” or “B component” is a component of the multi-component composition which comprises at least one amine that is reactive with respect to isocyanate groups and/or at least one alcohol that is reactive with respect to isocyanate groups. The “B component” can optionally additionally comprise at least one filler and/or at least one rheology additive and/or further additives:
“a” or “an” as the article preceding a class of chemical compounds, e.g., preceding the word “isocyanate”, means that one or more compounds included in this class of chemical compounds, e.g., various isocyanates, may be meant. In a preferred embodiment, this article means only a single compound;
“at least one” means numerically “one or more.” In a preferred embodiment, the term numerically means “one”;
“contain”, “comprise” and “include” mean that further constituents may be present in addition to those mentioned. These terms are intended to be inclusive and therefore also encompass “consist of.” “Consist of” is intended to be exclusive and means that no further constituents may be present. In a preferred embodiment, the terms “contain”, “comprise” and “include” mean the term “consist of”;

### Temperature-Regulating Fillers

The foamable mufti-component composition according to the invention comprises at least one temperature-regulating filler. The temperature-regulating filler can be used in the isocyanate component (A) and/or in the B component. In a preferred embodiment of the invention, the temperature-regulating filler is contained at least in the B component. In a further preferred embodiment, the temperature-regulating filler is present only in the B component, and the isocyanate component (A) contains no temperature-regulating filler.

The term “temperature-regulating filler” denotes a filler which has a temperature-inhibiting effect, at least over a certain period of time, when heat is introduced (for example in the event of a fire). The temperature-regulating filler is preferably selected from the group consisting of endothermic fillers, fillers having a thermal conductivity of <1 W m−1 K−1 and mixtures thereof.

Endothermic fillers are those fillers which undergo an endothermic reaction when heat is introduced (for example in the case of fire). An endothermic reaction is a chemical reaction in which energy is absorbed from the surroundings.

Preferably, the endothermic reaction of the endothermic filler used is in a temperature range of 70° C. to 300° C. (referred to as onset temperature, determined by means of thermogravimetric analysis (TGA)), preferably in a temperature range of 70° C. to 200° C., in particular in a temperature range of 70° C. to 115° C. In the specified temperature ranges there is an equilibrium between the desired cooling mechanism and the reaction temperature of the fire-protection additive forming the insulation layer.

The endothermic filler is preferably used in a weight percentage range of 1 to 70 based on the total weight of the multi-component composition, in particular in a fraction of 10 wt. % to 15 wt. %, in the multi-component composition according to the invention.

Crystalline or semi-crystalline inorganic compounds which contain hydration water (H₂O) are one option when selecting the endothermic fillers. Hydration water or also water of crystallization is a designation for water which occurs bound in the crystalline or semi-crystalline solids. The release of the hydration water from the crystalline/semi-crystalline inorganic compound takes place via an endothermic reaction. It is particularly advantageous to use crystalline or semi-crystalline solids which have as high a fraction of water of crystallization as possible. The weight percentage fraction of water of crystallization with respect to the crystalline or semi-crystalline solid used is preferably at least 15 wt. %, preferably at least 20 wt. %.

Crystalline or semi-crystalline inorganic compounds comprising water of crystallization are preferably selected from the group consisting of ettringites, layered double hydroxides (Layered Double Hydroxides, LDH) or mixtures thereof.

The term ettringites within the meaning of the present invention denotes calcium aluminum sulfate hydrates. Naturally occurring ettringite minerals have a composition having the structural formula Ca₆Al₂[(OH)₁₂(SO₄)₃]·26 H₂O. Ettringites can also be produced synthetically. In a preferred embodiment of the invention, synthetically produced ettringite having the formula 3 CaO×Al₂O₃×3 CaSO₄×32 H₂O is used as the endothermic filler. This is commercially available, for example under the trade name CASUL powder H1i. A positive endothermic effect can already be observed from an amount of at least 1 wt. % ettringite based on the total weight of the foamable multi-component composition. In a preferred embodiment, the weight percentage fraction of ettringite, based on the total weight of the foamable multi-component composition, is 1 wt. % to 50 wt. %, preferably 10 to 25 wt. %.

The term layered double hydroxides (LDHs) denotes a compound class of ionic solids which has a layer structure having the molecular structure [M(II)₁₋ₓM(III)ₓ(OH)₂]^{x+}(Aⁿ⁻_{x/n})·mH₂O, where x is a number from 0.22 to 0.33, M is a metal, and Aⁿ⁻ is an n-valent anion. LDHs are usually synthetic materials derived from natural hydrotalcite, Mg₆Al₂(OH)₁₆[CO₃]·4H₂O. In the context of the present invention, those LDHs which have a MgO:Al₂O₃ ratio of 70:30 are particularly suitable. This is commercially available under the trade name PLURAL MG70, for example. In a preferred embodiment, the weight percentage fraction of LDH, based on the total weight of the multi-component composition, is 7 wt. % to 50 wt. %, preferably 10 to 30 wt. %.

Furthermore, materials having a low thermal conductivity can also be used as temperature-regulating fillers. Within the meaning of the present invention, materials having a low thermal conductivity have a thermal conductivity of <1 W m⁻¹K⁻¹. Corresponding materials impart a thermally insulating effect to the fire-protection profile in the event of a fire.

The use of brick dust is particularly advantageous in this context. Brick dust has a thermal conductivity of 0.3 to 0.7 W m⁻¹K⁻¹.

Brick dust is obtained by grinding bricks. The term “brick” within the meaning of the present invention is understood to mean all masonry bricks within the meaning of DIN EN 771-1. Accordingly, masonry bricks are masonry stones which are fired from clay or other clay-containing substances with or without sand or other additives at a sufficiently high temperature in order to achieve a ceramic compound. The term “masonry stone” is understood to mean a preformed element for producing masonry. Ceramic clinker or finely ground ceramic, e.g., sanitary ceramics, can also be used.

In principle, brick dust of different particle sizes can be used. Following the grinding process, the brick dust is usually subjected to a sieving process. By choosing the sieve(s) having a defined mesh size in the sieving process, the particle size of the brick dust used is set to a defined particle size range. For example, the brick dust has particles having a size of ≤0.3 mm (particle size range >0 to 0.3 mm) when using a sieve having a mesh size of 0.3 mm. However, due to the different orientation of the particles of the brick dust during the sieving process, it is also possible for a small proportion of the particles to be greater than the mesh size of the sieve. This occurs in particular in the case of asymmetrically shaped particles (for example rod-shaped). In order to take account of this circumstance, the so-called d₉₀ value is used for the specification of the particle size in the context of the present invention. The d₉₀ value is a parameter indicating that 90% of the sample volume has a smaller particle size than the specified value. The d₉₀ value in the context of the present invention is determined by means of static light scattering (device: Beckman Coulter LS 13 320/Dry Powder System). In a particularly preferred embodiment, the brick dust has a d₉₀ value in a range of 0.5 mm to 0.01 mm, preferably in a range of 0.35 mm to 0.05 mm, more preferably in a range of 0.30 mm to 0.1 mm.

The brick dusts which are advantageously to be used are commercially available for example from Pilosith GmbH, Peter Stadler GmbH or Kalkladen GmbH.

In a preferred embodiment, the weight percentage fraction of brick dust, based on the total weight of the foamable multi-component composition, is 1 wt. % to 70 wt. %, preferably 10 to 40 wt. %, more preferably 15 to 25 wt. %.

Furthermore, what are known as aerogels are suitable for use as fillers having low thermal conductivity, within the context of the present invention. The term aerogel is understood to mean highly porous solids in which >90% of the volume consists of pores. Aerogels typically have a thermal conductivity in the region of approximately 0.2 W m⁻¹ K⁻¹. Preferably, in the context of the present invention, silicate-based aerogels are used.

However, it is also conceivable for aerogels based on plastics material and/or carbon to be used. Aerogel particles P100 from Cabot are available commercially, for example.

Due to the low weight of the aerogel particles, the quantity indication is usually volumetric and not gravimetric. In a preferred embodiment of the invention, 7 to 80 ml, preferably 20 to 70 ml, aerogel are used per 100 g of the foamable multi-component composition. The use of a higher amount of aerogel particles results in no more foam being obtained during the production of the foamed fire-protection profile, but rather a porous mass.

In a particularly preferred embodiment of the invention, the foamable multi-component composition comprises both an endothermic filler and a filler having a thermal conductivity of <1 W m⁻¹K⁻¹. As a result, in the event of a fire, the heat input is initially delayed by the insulating effect of the filler having low thermal conductivity. As soon as the reaction temperature of the endothermic filler is reached, an “active cooling” additionally takes place via the endothermic reaction. In a particularly preferred embodiment, the endothermic filler and the filler having a thermal conductivity of <1 W m⁻¹K⁻¹ are used in a weight percentage ratio of 1:1.

### Isocyanate Component (A)

The multi-component system according to the invention comprises at least one isocyanate component (A) and at least one component (B) that is reactive with respect to isocyanate groups. Before use, the isocyanate component (A) and the component (B) that is reactive with respect to isocyanate groups are provided separately from one another in a reaction-inhibiting manner.

The isocyanate component (A) comprises at least one polyisocyanate. All aliphatic and/or aromatic isocyanates known to a person skilled in the art and having an average NCO functionality of 2 or more, individually or in any mixtures with one another, can be used as the polyisocyanate. The NCO functionality indicates how many NCO groups are present in the polyisocyanate. Polyisocyanate means that two or more NCO groups are contained in the compound.

Suitable aromatic polyisocyanates are those having aromatically bound isocyanate groups, such as diisocyanatobenzenes, toluene diisocyanates, diphenyl diisocyanates, diphenylmethane diisocyanates, diisocyanatonaphathalenes, triphenylmethane triisocyanates, but also those having isocyanate groups that are bound to an aromatic group via an alkylene group, such as a methylene group, such as bis- and tris-(isocyanatoalkyl) benzenes, toluenes and xylenes.

Preferred examples of aromatic polyisocyanates are: 1,3-phenylene diisocyanate, 1,4-phenylene diisocyanate, 2,4-toluylene diisocyanate, 2,5-toluylene diisocyanate, 2,6-toluylene diisocyanate, 1,3-xylylene diisocyanate, 1,4-xylylene diisocyanate, tetramethyl-1,3-xylylene diisocyanate, tetramethyl-1,4-xylylene diisocyanate, 1,3-bis(isocyanatomethyl)benzene, 1,4-bis(isocyanatomethyl)benzene, ethylphenyl diisocyanate, 2-dodecyl-1,3-phenylene diisocyanate, 2,4,6-triisopropyl-m-phenylene diisocyanate, 2,4,6-trimethyl-1,3-phenylene diisocyanate, xylylene diisocyanate, 1,5-naphthylene diisocyanate, 3,3′-dimethyl-4,4′-biphenyl diisocyanate, 3,3′-dimethoxy-4,4′-biphenyl diisocyanate, 3,3′-dimethyl-4,4′-biphenyl diisocyanate, diphenylene methane-2,4′-diisocyanate, diphenylene methane-2,2′-diisocyanate, diphenylene methane-4,4′-diisocyanate, triphenylmethane-4,4′,4″-triisocyanate, 5-(p-isocyanatobenzyl)-2-methyl-m-phenylene diisocyanate, 4,4-diisocyanato-3,3,5,5-tetraethyldiphenylmethane, 5,5′-ureylene di-o-tolyl diisocyanate, 4-[(5-isocyanato-2-methylphenyl)methy]-m-phenylene diisocyanate, 4-[(3-isocyanato-4-methylphenyl)methy]-m-phenylene diisocyanate, 2,2′-methylene-bis[6-(o-isocyanatobenzyl)phenyl]diisocyanate.

Aliphatic isocyanates which have a carbon backbone (without the NCO groups contained) of 3 to 30 carbon atoms, preferably 4 to 20 carbon atoms, are preferably used.

Examples of aliphatic polyisocyanates are bis(isocyanatoalkyl) ethers or alkane diisocyanates such as methane diisocyanate, propane diisocyanates, butane diisocyanates, pentane diisocyanates, hexane diisocyanates (e.g., hexamethylene diisocyanate, HDI), heptane diisocyanates (e.g., 2,2-dimethylpentane-1,5-diisocyanate, octane diisocyanates, nonane diisocyanates (e.g., trimethyl HDI (TMDI) usually as a mixture of the 2,4,4- and 2,2,4-isomers), 2-methylpentane-1,5-diisocyanate (MPDI), nonane trisocyanates (e.g., 4-isocyanatomethyl-1,8-octane diisocyanate, 5-methylnonane diisocyanate), decane diisocyanates, decane triisocyanates, undecane disocyanates, undecane triisocyanates, dodecane diisocyanates, dodecane triisocyanates, 1,3- and 1,4-bis-(isocyanatomethyl)cyclohexane (H₆XDI), 3-isocyanatomethyl-3,5,5-trimethylcyclohexyl isocyanate (isophorone diisocyanate, IPDI), bis-(4-isocyanatocyclohexyl)methane (H₁₂MDI), bis-(isocyanatomethyl)norbomane (NBDI) or 3(4)-isocyanatomethyl-1-methyl-cyclohexyl isocyanate (IMCI), octagydro-4,7-methano-1H-indenedimethyl diisocyanate, norbornene diisocyanate, 5-isocyanato-1-(isocyanatomethyl)-1,3,3-trimethylcyclohexane, ureylene-bis(p-phenylenemethylene-p-phenylene)diisocyanate.

Particularly preferred isocyanates are hexamethylene diisocyanate (HDI), trimethyl HDI (TMDI), pentane diisocyanate (PDI), 2-methylpentane-1,5-diisocyanate (MPDI), isophorone diisocyanate (IPDI), 1,3- and 1,4-bis-(isocyanatomethyl)cyclohexane (H₆XDI), bis-(isocyanatomethyl)norbomane (NBDI), 3(4)-isocyanatomethyl-1-methyl-cyclohexyl isocyanate (IMCI) and/or 4,4′-bis(isocyanatocyclohexyl)methane (H₁₂MDI) or mixtures of these isocyanates.

Even more preferably, the polyisocyanates are present as prepolymers, biurets, isocyanurates, iminooxadiazinediones, uretdiones and/or allophanates, which can be produced by oligomerizing difunctional isocyanates or by reacting the isocyanate compounds with polyols or polyamines, individually or as a mixture, and which have an average NCO functionality of 2 or more.

Examples of suitable, commercially available isocyanates are Desmodur® N 3900, Desmodur® N 100, Desmodur® Ultra N 3200, Desmodur® Ultra N 3300, Desmodur® Ultra N 3600, Desmodur® N 3800, Desmodur® XP 2675, Desmodur® 2714, Desmodur® 2731, Desmodur® N 3400, Desmodur® XP 2679, Desmodur® XP 2731, Desmodur® XP 2489, Desmodur® E 3370, Desmodur® XP 2599, Desmodur® XP 2617, Desmodur® XP 2406. Desmodur® XP 2551, Desmodur® XP 2838, Desmodur® XP 2840, Desmodur® VL, Desmodur® VL 50, Desmodur® VL 51, Desmodur® ultra N 3300, Desmodur® eco N 7300, Desmodur® E23, Desmodur® E XP 2727, Desmodur® E 30600, Desmodur® E 2863 XP Desmodur® H, Desmodur® VKS 20 F, Desmodur® 44V201, Desmodur® 44P01, Desmodur®44V70 L, Desmodur® N3400, Desmodur® N3500 (all available from Covestro AG), Tolonate™ HDB, Tolonate™ HDB-LV, Tolonate™ HDT. Tolonate™ HDT-LV, Tolonate™ HDT-LV2 (available from Vencorex), Basonat® HB 100, Basonat® HI 100, Basonat® HI 2000 NG (available from BASF), Takenate® 500, Takenate®600, Takenate® D-132N(NS), Stabio® D-376N (all available from Mitsui), Duranate® 424A-100, Duranate® TPA-100, Duranate® TPH-100 (all available from Asahi Kasai), Coronate® HXR, Coronate® HXLV, Coronate® HX, Coronate® HK (all available from Tosoh).

The weight percentage ratios of the isocyanate compound and of the group reactive with respect to isocyanate groups in the B component are preferably selected such that the equivalent ratio of isocyanate groups to groups reactive with respect to the isocyanate groups is between 0.3 and 1.7, preferably between 0.5 and 1.5, and more preferably between 0.9 and 1.4.

Component (B), Reactive with Respect to Isocyanate Groups

According to the invention, the foamable multi-component composition comprises at least one component (B) which is reactive with respect to isocyanate groups. The component which is reactive with respect to isocyanate groups preferably comprises at least one compound selected from the group consisting of compounds having at least two amino groups, polyols and combinations thereof.

Usable amines include all compounds having at least two amino groups, the amino groups being primary and/or secondary amino groups which are capable of reacting with isocyanate groups to form a urea group (—N—C(O)—N), these compounds being known in principle to a person skilled in the art.

According to a preferred embodiment, the amine that is reactive with respect to isocyanate groups is selected from the group consisting of aliphatic, alicyclic, araliphatic and aromatic amines.

Amines which are reactive with respect to isocyanate groups are known in principle to a person skilled in the art. Examples of suitable amines which are reactive with respect to isocyanate groups are given below, but without restricting the scope of the invention. These can be used either individually or in any mixtures with one another. Examples are: 1,2-diaminoethane(ethylenediamine), 1,2-propanediamine, 1,3-propanediamine, 1,4-diaminobutane. 2,2-dimethyl-1,3-propanediamine (neopentanediamine), diethylaminopropylamine (DEAPA), 2-methyl-1,5-diaminopentane, 1,3-diaminopentane, 2,2,4- or 2,4,4-trimethyl-1,6-diaminohexane and mixtures thereof (TMD), 1,3-bis(aminomethyl)-cyclohexane, 1,2-bis(aminomethyl)cyclohexane, hexamethylenediamine (HMD), 1,2- and 1,4-diaminocyclohexane (1,2-DACH and 1,4-DACH), bis(4-amino-3-methylcyclohexyl)methane, diethylenetriamine (DETA), 4-azaheptane-1,7-diamine, 1,11-diamino-3,6,9-trioxundecane, 1,8-diamino-3,6-dioxaoctane, 1,5-diamino-methyl-3-azapentane, 1,10-diamino-4,7-dioxadecane, bis(3-aminopropyl)amine, 1,13-diamino-4,7,10-trioxatridecane, 4-aminomethyl-1,8-diaminooctane, 2-butyl-2-ethyl-1,5-diaminopentane, N,N-bis(3-aminopropyl)methylamine, triethylenetetramine (TETA), tetraethylenepentamine (TEPA), pentaethylenehexamine (PEHA), 1,3-benzenedimethanamine (m-xylylenediamine, mXDA), 1,4-benzenedimethanamine (p-xylylenediamine, pXDA), 5-(aminomethyl)bicyclo[[2.2.1]hept-2-yl]methylamine (NBDA, norbornane diamine), dimethyldipropylenetriamine, dimethylaminopropylaminopropylamine (DMAPAPA), 2,4-diamino-3,5-dimethyfthiotoluene (dimethylthio-toluene diamine DMTDA), 3-aminomethyl-3,5,5-trimethylcyclohexyl amine (isophorone diamine (IPDA)), diaminodicyclohexylmethane (PACM), diethylmethylbenzenediamine (DETDA), 3,3′-diaminodiphenylsulfone (dapsone), mixed polycyclic amines (MPCA) (e.g., Ancamine 2168), dimethyldiaminodicyclohexylmethane (Laromin C260), 2,2-bis(4-aminocyclohexyl)propane, (3(4),8(9)bis(aminomethyl)tricyclo[5.2.1.02,6]decane (mixture of isomers, tricyclic primary amines: TCD diamine), methylcyclohexyl diamine (MCDA), N,N′-diaminopropyl-2-methyl-cyclohexane-1,3-diamine, N,N′-diaminopropyl-4-methyl-cyclohexane-1,3-diamine, N-(3-aminopropyl)cyclohexylamine, and 2-(2,2,6,6-tetramethylpiperdin-4-yl)propane-1,3-diamine.

What are known as polyether polyamines can also be used as amines. The polyether polyamines, also called alkoxylated polyamines or polyoxyalkenylamines, comprise compounds having aliphatically bound amino groups, i.e., the amino groups are bound to the ends of a polyether skeleton. The polyether skeleton is based on pure or mixed polyalkylene oxide units, such as polyethylene glycol (PEG), polypropylene glycol (PPG). The polyether skeleton is obtainable by reaction of a di- or tri-alcohol initiator with ethylene oxide (EO) and/or propylene oxide (PO) and subsequent conversion of the terminal hydroxyl groups to amino groups.

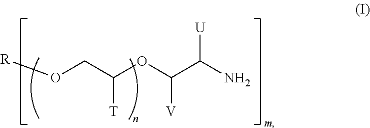

in which
R: is the group of an initiator for oxyalkylation having 2 to 12 carbon atoms and 2 to 8 groups having active hydrogen atoms,
T: represents hydrogen or a C₁-C₄ alkyl group,
V and U: are, independently of one another, hydrogen or T,
n: is a value between 0 and 100,
m: is an integer between 2 and 8, m corresponding to the number of groups having an active hydrogen atom which were originally contained in the oxyalkylation initiator.

In further embodiments, n has a value between 35 and 100 or less than 90, less than 80, and less than 70, or less than 60. In a further embodiment, R has 2 to 6 or 2 to 4 or 3 groups having active hydrogen atoms, in particular hydroxyl groups. In another embodiment, R is an aliphatic initiator having a plurality of active hydrogen atoms. In a further embodiment, T, U and V are each methyl groups.

Examples of suitable polyetheramines are the polyetheramines of the D-, ED-, EDR- and T-series marketed by Huntsman Corporation under the trademark JEFFAMINE®, the D-series comprising diamines and the T-series comprising triamines, the E-series comprising compounds which have a skeleton which consists substantially of polyethylene glycol, and the R series comprising highly reactive amines.

The products of the D series comprise amino-terminated polypropylene glycols of the general formula (II),

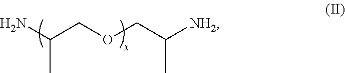

in which x is a number having an average value between 2 and 70. Commercially available products from this series are JEFFAMINE® D-230 (n˜2.5/Mw 230), JEFFAMINE® D-400 (n˜6.1/Mw=430), JEFFAMINE® D-2000 (n˜33/Mw 2000) and JEFFAMINE® D-4000 (n˜68/MW 4000).

The products of the ED series comprise amino-terminated polyethers based on a substantially polyethylene glycol skeleton having the general formula (III),

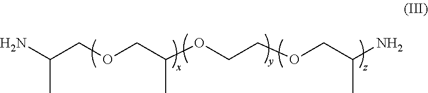

in which y is a number having an average value of between 2 and 40, and x+z is a number having an average value between 1 and 6. Commercially available products from this series are: JEFFAMINE® HK511 (y=2.0; x+z˜1.2/Mw 220), JEFFAMINE® ED-600 (y˜9.0; x+z˜3.6/Mw 600), JEFFAMINE® ED-900 (y˜12.5; x+z˜6.0/Mw 900) and JEFFAMINE® ED-2003 (y˜39; x+z˜6.0/Mw 2000).

The products of the EDR series comprise amino-terminated polyethers having the general formula (IV)

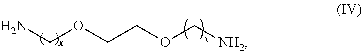

in which x is an integer between 1 and 3. Commercially available products from this series are: JEFFAMINE® DER-148 (x=2/Mw 148) and JEFFAMINE® DER-176 (x=3/Mw 176). The products of the T series comprise triamines obtained by reaction of propylene oxide with a triol initiator and subsequent amination of the terminal hydroxyl groups, and have the general formula (V) or isomers thereof

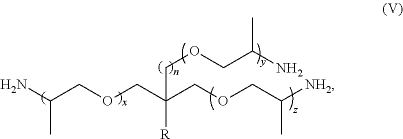

in which R is hydrogen or a C₁-C₄ alkyl group, preferably hydrogen or ethyl, n is 0 or 1, and x+y+z corresponds to the number of moles of propylene oxide units, where x+y+z is an integer between about 4 and about 100, in particular between about 5 and about 85. Commercially available products from this series are: JEFFAMINE® T-403 (R═C₂H₅; n=1; x+y+z=5-6/Mw 440), JEFFAMINE® T-3000 (R═H; n=0; x+y+z=50/Mw 3000) and JEFFAMINE® T-5000 (R═H: n=0; x+y+z=85/Mw 5000).

Furthermore, the secondary amines of the SD- and ST-series are suitable, the SD-series comprising secondary diamines and the ST-series comprising secondary triamines, which are obtained from the above series by reductive alkylation of the amino groups in which the amino end groups are reacted with a ketone, for example acetone, and subsequently reduced, such that sterically hindered secondary amino end groups having the general formula (VI) are obtained:

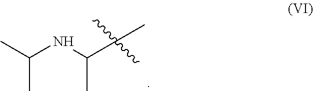

Commercially available products from this series are: JEFFAMINE® SD-231 (starting product D230/Mw 315), JEFFAMINE® SD-401 (starting product D-400/Mw 515), JEFFAMINE® SD-2001 (starting product D-2000/Mw 2050) and JEFFAMINE ST-404 (starting product T-403/Mw 565).

In one embodiment of the invention, polyaspartic esters are used as compounds having at least two amino groups, since their reactivity with respect to isocyanate groups is significantly reduced compared with the other polyamines described above.

Suitable polyaspartic esters are selected from compounds of the general formula (VII),

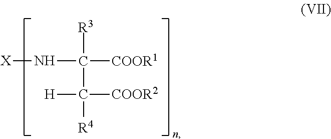

in which R¹ and R² can be the same or different and represent organic groups which are inert with respect to isocyanate groups,

R³ and R⁴ can be the same or different and stand for hydrogen or organic groups which are inert with respect to isocyanate groups, X is an n-valent organic group which is inert with respect to isocyanate groups, and n is an integer of at least 2, preferably from 2 to 6, more preferably from 2 to 4, and most preferably of 2. R¹ and R² preferably represent, independently of one another, an optionally substituted hydrocarbon group, preferably a C₁-C_{y} hydrocarbon group and more preferably a methyl, ethyl or butyl group, and R³ and R⁴ preferably in each case represent hydrogen.

In one embodiment, X stands for an n-valent hydrocarbon group obtained by removing the amino groups from an aliphatic or araliphatic polyamine, preferably by removing the primary amino groups from an aliphatic polyamine, particularly preferably diamine. The term polyamine includes, in this context, compounds having two or more primary and optionally additional secondary amino groups, the primary amino groups preferably being terminal.

In a preferred embodiment, X stands for a group as obtained by removal of the primary amino groups from 1,4-diaminobutane, 1,6-diaminohexane, 2,2,4- or 2,4,4-trimethyl-1, 6-diaminohexane, 1-amino-3,3,5-trimethyl-5-amidonmethylcyclohexane, 4,4′-diamino dicyclohexylmethane or 3,3′-dimethyl-4,4′-diamino dicyclohexylmethane, diethylenetriamine and triethylenetetramine, and where n in formula (VII) represents the number 2.

Mixtures of polyaspartic esters can likewise be used.

Examples of suitable polyaspartic esters are sold by Covestro AG under the trademark DESMOPHEN®. Commercially available products are, for example: DESMOPHEN® NH 1220, DESMOPHEN® NH 1420 and DESMOPHEN® NH 1520. The compounds described comprising at least two amino groups can be used individually or as a mixture, depending on the desired reactivity. In this case, in particular the polyamines can serve as bridging compounds if they are used in addition to the polyetherpolyamines or polyaspartic esters.

If polyols are used as the components that are reactive with respect to isocyanate compounds, all compounds having two or more hydroxyl groups are possible. The polyol is preferably composed from a basic skeleton of polyester, polyether, polyurethane and/or alkanes or mixtures thereof. The basic skeleton may be linear or branched, and the functional hydroxyl groups may be contained terminally and/or along the chain.

In a preferred embodiment, the polyol contains one or more polyester polyols. The polyester polyols are preferably selected from condensation products of di- and polycarboxylic acids, e.g., aromatic acids such as phthalic acid and isophthalic acid, aliphatic acids such as adipic acid and maleic acid, cycloaliphatic acids such as tetrahydrophthalic acid and hexahydrophthalic acid and/or their derivatives, such as anhydrides, esters or chlorides, and an excess quantity of multifunctional alcohols, e.g., aliphatic alcohols such as ethanediol. 1,2-propanediol, 1,6-hexanediol, neopentyl glycol, glycerol, trimethylolpropane and cycloaliphatic alcohols such as 1,4-cyclohexanedimethanol.

Furthermore, the polyester polyols are selected from polyacrylate polyols, such as copolymers of esters of acrylic and/or methacrylic acid, such as ethyl acrylate, butyl acrylate, methyl methacrylate having additional hydroxyl groups, and styrene, vinyl esters and maleic acid esters. The hydroxyl groups in these polymers are introduced via functionalized esters of acrylic and methacrylic acid, e.g., hydroxyethyl acrylate, hydroxyethyl methacrylate and/or hydroxypropyl methacrylate.

Furthermore, the polyester polyols are selected from polycarbonate polyols. Usable polycarbonate polyols are polycarbonates comprising hydroxyl groups, for example polycarbonate diols. These are obtainable by reaction of carbonic acids or carbonic acid derivatives with polyols or by the copolymerization, with CO₂, of alkylene oxides, such as, for example, propylene oxide. Additionally or alternatively, the polycarbonates being used are composed of linear aliphatic chains. Examples of suitable carbonic acid derivatives are carbonic acid diesters, such as, for example, diphenyl carbonate, dimethyl carbonate or phosgene.

Instead of or in addition to pure polycarbonate diols, polyether polycarbonate diols may also be used.

Furthermore, the polyester polyols are selected from polycaprolactone polyols, produced by ring-opening polymerization of ε-caprolactone with multifunctional alcohols, such as ethylene glycol, 1,2-propanediol, glycerol and trimethylolpropane.

Furthermore, polyether polyols selected from addition products of, for example, ethylene and/or propylene oxide and polyfunctional alcohols such as ethylene glycol, 1,2-propanediol, glycerol and/or trimethylolpropane are more preferred.

Moreover, polyurethane polyols produced from polyaddition of diisocyanates with excess quantities of diols and/or polyols are more preferred.

Difunctional or polyfunctional alcohols selected from C₂-C₁₀ alcohols comprising the hydroxyl groups at the ends and/or along the chain are in addition more preferred.

Above-mentioned polyester polyols, polyether polyols and C₂-C₁₀ alcohols that are difunctional and/or trifunctional and/or tetrafunctional are most preferred.

Examples of suitable polyester polyols include DESMOPHEN® 1100, DESMOPHEN® 1652, DESMOPHEN® 1700, DESMOPHEN® 1800, DESMOPHEN® 670, DESMOPHEN®800, DESMOPHEN®850, DESMOPHEN® VP LS 2089, DESMOPHEN® VP LS 2249/1, DESMOPHEN® VP LS 2328, DESMOPHEN® VP LS 2388, DESMOPHEN® XP 2488 (Covestro AG), K-FLEX XM-360, K-FLEX 188, K-FLEX XM-359, K-FLEX A308 and K-FLEX XM-332 (King Industries).

Examples of suitable commercially available polyether polyols include: ACCLAIM® POLYOL 12200 N, ACCLAIMS POLYOL 18200 N, ACCLAIMS POLYOL 4200, ACCLAIM® POLYOL 6300, ACCLAIM® POLYOL 8200 N, ARCOL® POLYOL 1070, ARCOL® POLYOL 1 105 S, DESMOPHEN® 11 10 BD, DESMOPHEN®1111 BD, DESMOPHEN®1262 BD. DESMOPHEN®1380 BT, DESMOPHEN® 1381 BT, DESMOPHEN® 1400 BT, DESMOPHEN®2060 BD, DESMOPHEN®2061 BD, DESMOPHEN®2062 BD, DESMOPHEN®3061 BT, DESMOPHEN® 401 1 T, DESMOPHEN®4028 BD DESMOPHEN®4050 E, DESMOPHEN® 5031 BT, DESMOPHEN® 5034 BT, DESMOPHEN®10WF15, DESMOPHEN® 10WF16, DESMOPHEN® 10WF18, DESMOPHEN®5168T and DESMOPHEN®5035 BT (Bayer; Covestro); Lupranol 2043, Lupranol 2048. Lupranol 2090, Lupranol 2092. Lupranol 2095, Pluriol E600 (BASF); Voranol CP 755, Voranol RA 800, Voranol CP 6001, Voranol EP 1900 (Dow) or mixtures of polyesters and polyether polyols such as WorleePol 230 (Worlee).

Examples of suitable alcohols include ethanediol, propanediol, propanetriol, butanediol, butanetriol, pentanediol, pentanetriol, hexanediol, hexanetriol, heptanediol, heptanetriol, octanediol, octanteriol, nonanediol, nonanetriol, decanediol and decanetriol.

In a preferred embodiment, the component (B) which is reactive with respect to isocyanate groups comprises a mixture of one or more compounds having two amino groups and one or more polyols. A mixture of one or more polyols with one or more polyaspartic esters is particularly preferred, in particular a mixture of one or more polyaspartic esters with triols and/or Tetracaine being preferred.

A catalyst is preferably used for the reaction of the isocyanate compound with the component that is reactive with respect to isocyanate groups. The catalyst is preferably selected from amines, tin-containing compounds, bismuth-containing compounds, zirconium-containing compounds, aluminum-containing compounds or zinc-containing compounds. These are preferably tin octoate, tin oxalate, tin chloride, dioctyttin di-(2-ethylhexanoate), dioctyttin dilaurate, dioctyttin dithioglycolate, dibutyltin dilaurate, monobutyltin tris-(2-ethylhexanoate), dioctyltin dineodecanoate, dibutyltin dineodecanoate, dibutyltin diacetate, dibutyltin oxide, monobutyltin-dihydroxychloride, organotin oxide, monobutyl tin oxide, dioctyltin dicarboxylate, dioctyltin stannoxane, bismuth carboxylate, bismuth oxide, bismuth neodecanoate, zinc neodecanoate, zinc octoate, zinc acetylacetonate, zinc oxalate, zinc acetate, zinc carboxylate, aluminum chelate complex, zirconium chelate complex, dimethylaminopropylamine, N,N-dimethylcyclohexylamine, N,N-dimethylethanolamine, N-(3-dimethylaminopropy)-N,N-diisopropanolamine, N-ethylmorpholine, N-methylmorpholine, pentamethyldiethylenetriamine and/or triethylenediamine. Examples of suitable catalysts are Borchi® Kat 24, Borchi® Kat 320, Borchi® Kat 15 (Borchers), TIB KAT 129, TIB KAT P129, TIB KAT 160, TIB KAT 162, TIB KAT 214, TIB KAT 216, TIB KAT 218, TIB KAT 220, TIB KAT 232. TIB KAT 248. TI B KAT 248 LC. TI B KAT 250, TIB KAT 250, TIB KAT 256, TIB KAT 318, TIB Si 2000, TIB KAT 716, TIB KAT 718, TIB KAT 720, TIB KAT 616, TIB KAT 620, TIB KAT 634, TIB KAT 635, (TIB Chemicals), K-KAT® XC—B221, K-KAT®348, K-KAT® 4205, K-KAT® 5218, K-KAT® XK-635, K-KAT® XK-639, K-KAT® XK-604, K-KAT® XK-618 (King Industries), JEFFCAT® DMAPA, JEFFCAT® DMCHA, JEFFCAT® DMEA, JEFFCAT® DPA. JEFFCAT® NEM, JEFFCAT® NMM, JEFFCAT® PMDETA, JEFFCAT® TD-100 (Huntsman) and DABCO 33LV (Sigma Aldrich). Particularly preferably, the multi-component composition comprises at least one tin-containing compound as catalyst.

According to the invention, the composition contains an additive that forms an insulation layer, it being possible for the additive to comprise an individual compound and a mixture of a plurality of compounds.

It is expedient if, as an additive that forms an insulation layer, additives are used of the type that act by forming an expanded insulating layer that forms under the effect of heat, composed of a material having low flammability, which protects the substrate from overheating and thereby prevents or at least delays a change in the mechanical and static properties of supporting structural parts due to the effect of heat. The formation of a voluminous insulation layer, namely an ash layer, can be formed by means of the chemical reaction of a mixture of corresponding compounds, matched to one another, which react with one another under the effect of heat. Systems of this kind are known to a person skilled in the art as chemical intumescence and can be used according to the invention. Alternatively, the voluminous, insulating layer can be formed by means of physical intumescence. The two systems can each be used according to the invention either alone or together as a combination.

For the formation of an intumescent layer by means of chemical intumescence, at least three components are generally required, a carbon source, a dehydrogenation catalyst, and a gas former, which are often contained in a binder. Under the effect of heat, the binder softens, and the fire-protection additives are released, such that these react with one another, in the case of chemical intumescence, or can expand, in the case of physical intumescence. The acid that serves as the catalyst for carbonization of the carbon source is formed from the dehydrogenation catalyst, by means of thermal decomposition. At the same time, the gas former decomposes thermally with formation of inert gases, which bring about expansion of the carbonized (burnt) material and optionally the softened binder, forming a voluminous, insulating foam.

In an embodiment of the invention in which the insulating layer is formed by means of chemical intumescence, the additive forming the insulation layer comprises at least one carbon-skeleton former, if the binder cannot be used as such, at least one acid former, at least one gas former, and at least one inorganic skeleton former. The components of the additive are particularly selected in such a manner that they can develop synergy, wherein some of the compounds can fulfill multiple functions.

Compounds usually used in intumescent fire-protection agents and known to a person skilled in the art are possible carbon suppliers, such as compounds similar to starch, for example starch and modified starch, and/or multivalent alcohols (polyols), such as saccharides and polysaccharides and/or a thermoplastic or duroplastic polymer resin binder, such as a phenolic resin, a urea resin, a polyurethane, polyvinyl chloride, poly(meth)acrylate, polyvinyl acetate, polyvinyl alcohol, a silicone resin and/or a natural rubber. Suitable polyols are polyols from the group of sugar, pentaerythritol, dipentaerythritol, tripentaerythritol, polyvinyl acetate, polyvinyl alcohol, sorbitol and EO-PO-polyols. Preferably, pentaerythrite, dipentaerythrite or polyvinyl acetate are used.

It should be mentioned that the polymer which serves as a binder can also itself have the function of a carbon source in the event of a fire, such that the addition of an additional carbon source is not always necessary.

Compounds usually used in intumescent fire-protection formulations and known to a person skilled in the art are possible as dehydrogenation catalysts or acid formers, such as a salt or an ester of an inorganic, non-volatile acid, selected from sulfuric acid, phosphoric acid or boric acid. Mainly phosphorus-containing compounds, the range of which is very broad, are used, since they extend over several oxidation states of phosphorus, such as phosphines, phosphine oxides, phosphonium compounds, phosphates, elemental red phosphorus, phosphites and phosphates. The following may be mentioned by way of example as phosphoric acid compounds: monoammonium phosphate, diammonium phosphate, ammonium phosphate, ammonium polyphosphate, melamine phosphate, melamine resin phosphates, potassium phosphate, polyol phosphates such as pentaerythritol phosphate, glycerol phosphate, sorbitol phosphate, mannitol phosphate, dulcitol phosphate, neopentyl glycol phosphate, ethylene glycol phosphate, dipentaerythritol phosphate and the like. Preferably, a polyphosphate or an ammonium polyphosphate is used as a phosphoric acid compound. In this case, melamine resin phosphates are to be understood to include compounds such as the reaction products of Lamelite C (melamine-formaldehyde resin) with phosphoric acid. The following can be mentioned by way of example as sulfuric acid compounds: ammonium sulfate, ammonium sulfamate, nitroaniline bisulfate, 4-nitroaniline-2-sulfonic acid and 4,4-dinitrosulfanilamide and the like. Melamine borate can be mentioned by way of example as a boric acid compound.

Possible gas formers are the compounds usually used in fire-protection agents and known to a person skilled in the art, such as cyanuric acid or isocyanic acid and the derivatives thereof, melamine and the derivatives thereof. Such compounds are cyanamide, dicyanamide, dicyandiamide, guanidine and its salts, biguanide, melamine cyanurate, cyanic acid salts, cyanic acid esters and amides, hexamethoxymethyl melamine, dimelamine pyrophosphate, melamine polyphosphate and melamine phosphate. Preferably, hexamethoxymethyl melamine or melamine (cyanuric acid amide) is used.

Furthermore, components of which the effect is not limited to a single function, such as melamine polyphosphate, which acts both as an acid former and as a gas former, are suitable. Further examples are described in GB 2 007 689 A1, EP 139 401 A1 and U.S. Pat. No. 3,969,291 A1.

In an embodiment of the invention, in which the insulating layer is formed by means of physical intumescence, the additive forming the insulation layer comprises at least one thermally expandable compound, such as a graphite intercalation compound, which compounds are also known as expandable graphite. These can also be contained in the binder, particularly homogeneously.

For example, known intercalation compounds of sulfuric acid, nitric acid, acetic acid, Lewis acids and/or other strong acids in graphite are possible as expandable graphite. These are also referred to as graphite salts. Expandable graphites that emit SO₂, SO₃, CO₂, H₂O, NO and/or NO₂ at temperatures of 120 to 350° C., for example, causing expansion, are preferred. The expandable graphite can be present, for example, in the form of small plates having a maximum diameter in the range of 0.1 to 5 mm. Preferably, this diameter lies in the range of 0.5 to 3 mm. Expandable graphites suitable for the present invention are commercially available. In general, the expandable graphite particles are uniformly distributed in the fire-protection elements according to the invention.

In a further embodiment of the invention, the insulating layer is formed both by means of chemical and by means of physical intumescence, such that the additive that forms the insulation layer comprises not only a carbon source, a dehydrogenation catalyst, and a gas former, but also thermally expandable compounds.

In principle, the additive forming the insulation layer can be contained in the multi-component composition in a large weight percentage range, namely preferably in an amount of 10 to 70 wt. % based on the total weight of the multi-component composition. If the insulating layer is formed by physical intumescence, the additive forming the insulation layer is preferably contained in an amount of 10 to 40 wt. % based on the total weight of the multi-component composition. In order to in this case bring about the highest possible intumescence rate, the fraction of the additive forming the insulation layer, in the total formulation, is set as high as possible, it being necessary to ensure that the viscosity of the composition is not too high, in order that the composition can still be processed well. The fraction is preferably 12 to 35 wt. % and particularly preferably 15 to 30 wt. %, based on the total weight of the multi-component composition.

Since the ash crust formed in the event of a fire is generally too unstable, and, depending on its density and structure, can be blown away by air streams, for example, which has a negative impact on the insulating effect of the coating, preferably at least one ash-crust stabilizer is added to the components listed above. In this case, the fundamental mode of action is that the inherently very soft carbon layers which result are mechanically strengthened by inorganic compounds. The addition of such an ash-crust stabilizer contributes to significant stabilization of the intumescence crust in the event of a fire, because these additives increase the mechanical strength of the intumescent layer and/or prevent it from dripping off. The compounds usually used in fire-protection formulations and known to a person skilled in the art are usually possible as ash-crust stabilizers or skeleton formers, for example expandable graphite and particulate metals, such as aluminum, magnesium, iron, and zinc. The particulate metal can be present in the form of a powder, small plates, scales, fibers, threads and/or whiskers, the particulate metal in the form of powder, small plates or scales having a particle size of ≤50 μm, preferably of from 0.5 to 10 μm. In the case of use of the particulate metal in the form of fibers, threads and/or whiskers, a thickness of 0.5 to 10 μm and a length of 10 to 50 μm are preferred. Alternatively or additionally, an oxide or a compound of a metal from the group comprising aluminum, magnesium, iron or zinc can be used as an ash-crust stabilizer, particularly iron oxide, preferably iron trioxide, titanium dioxide, a borate, such as zinc borate and/or a glass frit composed of glass types having a low melting point, with a melting temperature of preferably at or above 400° C., phosphate or sulfate glass types, melamine poly-zinc-sulfates, ferroglass types or calcium boron silicates. The addition of such an ash-crust stabilizer contributes to significant stabilization of the ash crust in the event of a fire, since these additives increase the mechanical strength of the intumescent layer and/or prevent it from dripping off. Examples of such additives are also found in U.S. Pat. Nos. 4,442,157 A, 3,562,197 A, GB 755 551 A, as well as EP 138 546 A1.

In addition, ash-crust stabilizers such as melamine phosphate or melamine borate can be contained.

Optionally, one or more flame retardants can be added to the composition according to the invention, such as phosphate esters, halogen-containing compounds such as tri-(2-chloroisopropyl) phosphate (TOPP), tris(2-ethylhexyl) phosphate, dimethyl propane phosphonate, triethyl phosphate and the like. Some of such compounds are described, for example, in S. V. Levchik, E. D. Weil, Polym. Int. 2004. 53, 1901-1929. The flame retardants may preferably be present in an amount of 3 to 6 wt. %, based on the total composition.

According to the invention, the composition contains a blowing agent comprising one or more compounds capable of releasing carbon dioxide (CO₂) by reaction. All common chemical blowing agents which release carbon dioxide through chemical reaction between two constituents are suitable as blowing agents. According to the invention, the individual constituents of the blowing agent are separated from one another in a reaction-inhibiting manner before the composition is used.

In the simplest embodiment of the invention, the blowing agent comprises water or consists of water which releases carbon dioxide after mixing with the isocyanate of the isocyanate component (A). The weight percentage fraction of water is preferably 0.1 to 10 wt. %, more preferably 0.2 to 8 wt. %, and particularly preferably 0.2 to 6 wt. %, based on the total weight of the multi-component composition.

In a preferred embodiment of the invention, the multi-component composition comprises a foam catalyst which catalyzes the reaction of the isocyanate with water, forming carbon dioxide. In this case, N,N,N′-trimethyl-N′-hydroxyethyl bisaminoethyl ether (Jeffcat ZF-10), bis-(2-dimethylaminoethyl)ether (Jeffcat ZF-20), 70% bis-(2-dimethylaminoethyl)ether in dipropylene glycol (Jeffcat ZF-22). N-[2-[2-(dimethylamino)ethoxy]ethyl]-N-methyl-1,3-propanediamines (Dabco NE300) are preferably used.

In another embodiment, the blowing agent comprises an acid and a compound that is able to react with acids to form carbon dioxide.

Carbonate and hydrogen carbonate-containing compounds, in particular metal or (in particular quaternary) ammonium carbonates, such as carbonates of alkali metals or alkaline earth metals, for example CaCO3, NaHCOs, Na2CO3, K2CO3, (NH4) 003 and the like can be used as compounds which can react with acids to form carbon dioxide, chalk (CaCOs) being preferred. In this connection, various types of chalks with different grain sizes and different surface texture can be used, such as, for example, coated or uncoated chalk, or mixtures of two or more of those. Coated chalk types are preferably used, since they react more slowly with the acid and thus ensure controlled foaming or matched foaming and curing time.

Any acidic compound capable of reacting with carbonate or hydrogen carbonate-containing compounds with elimination of carbon dioxide, such as phosphoric acid, hydrochloric acid, sulfuric acid, ascorbic acid, polyacrylic acid, benzoic acid, toluenesulfonic acid, tartaric acid, glycolic acid, lactic acid; organic mono-, di- or polycarboxylic acids, such as acetic acid, chloroacetic acid, trifluoroacetic acid, fumaric acid, maleic acid, citric acid or the like, aluminum dihydrogenphosphate, sodium hydrogensulfate, potassium hydrogensulfate, aluminum chloride, urea phosphate, and other acid-releasing chemicals or mixtures of two or more thereof can be used as the acid. The acid generates the gas as the actual blowing agent.

As the acid component, an aqueous solution or an inorganic and/or organic acid may be used. Furthermore, buffered solutions of citric, tartaric, acetic, phosphoric acid and the like may be used.

In order to impart greater stability to the formed foam, the formed cells must remain stable until curing of the binder, in order to prevent collapse of the polymeric foam structure. Stabilization is all the more necessary the lower the density of the foamed material is to be, i.e., the greater the volume expansion is. Stabilization is usually achieved by means of foam stabilizers.

If necessary, therefore, the composition according to the invention may further contain a foam stabilizer. For example alkyl polyglycosides are possible as foam stabilizers. These are available according to methods known in themselves to the person skilled in the art, by reaction of longer-chain monoalcohols with mono-, di- or polysaccharides. The longer-chain monoalcohols, which optionally may also be branched, preferably have 4 to 22 C atoms, preferably 8 to 18 C atoms and particularly preferably 10 to 12 C atoms in an alkyl group. Specifically, 1-butanol, 1-propanol, 1-hexanol, 1-octanol, 2-ethylhexanol, 1-decanol, 1-undecanol, 1-dodecanol (lauryl alcohol), 1-tetradecanol (myristyl alcohol) and 1-octadecanol (stearyl alcohol) can be cited as longer-chain monoalcohols. Mixtures of the said longer-chain monoalcohols may also be used. Further foam stabilizers comprise anionic, cationic, amphoteric and nonionic surfactants known per se, and mixtures thereof. Alkyl polyglycosides, EO/PO block copolymers, alkyl or aryl alkoxylates, siloxane alkoxylates, esters of sulfosuccinic acid and/or alkali metal or alkaline earth metal alkanoates are preferably used. EO/PO block copolymers are particularly preferably used.

The foam stabilizers may be contained in any one of the components of the mufti-component composition according to the invention, as long as they do not react with one another.

In one embodiment, the composition according to the invention furthermore contains at least one further constituent, selected from plasticizers, cross-linkers, biocides, organic and/or inorganic admixtures and/or further additives.

The plasticizer has the task of plasticizing the cured polymer network. Furthermore, the plasticizer has the task of introducing an additional liquid component, such that the fillers are completely wetted and the viscosity is adjusted in such a manner that the coating becomes processable. The plasticizer can be contained in the formulation in such an amount that it can sufficiently fulfill the functions just described.

Suitable plasticizers are selected from derivatives of benzoic acid, phthalic acid, for example phthalates, such as dibutyl, dioctyl, dicyclohexyl, diisooctyl, diisodecyl, dibenzyl or butyl benzyl phthalate, trimellitic acid, pyromellitic acid, adipic acid, sebacic acid, fumaric acid, maleic acid, itaconic acid, caprylic acid and citric acid, alkyl phosphate esters and derivatives of polyesters and polyethers, epoxidized oils, C₁₀-C₂₁-alkylsulfonic esters of phenol and alkyl esters. Preferably the plasticizer is an ester derivative of terephthalic acid, a triol ester of caprylic acid, a glycol diester, diol ester of aliphatic dicarboxylic acids, ester derivative of citric acid, secondary alkylsulfonic acid ester, ester derivatives of glycerol with epoxy groups and ester derivatives of phosphates. More preferably, the plasticizer is bis-(2-ethylhexyl) terephthalate, trihydroxymethylpropyl caprylate.

triethylene glycol-bis(2-ethylhexanoate), 1,2-cyclohexane dicarboxylic acid diisononyl ester, a mixture of 75-85% secondary alkylsulfonic acid esters, 15-25% secondary alkane disulfonic acid diphenylesters, as well as 2-3% non-sulfonated alkanes, triethylcitrate, epoxy-enhanced soybean oil, tri-2-ethylhexylphosphate or a mixture of n-octylsuccinate and n-decylsuccinate. Most preferably, the plasticizer is a phosphate ester, since this can act both as a plasticizer and as a flame retardant.

The plasticizer can preferably be contained in the composition in an amount of up to 30 wt. %, more preferably up to 20 wt. %, and even more preferably up to 8 wt. %, based on the total composition.

Aside from the additives already described, the composition can optionally contain usual aids such as wetting agents, for example on the basis of polyacrylates and/or polyphosphates, dyes, fungicides, or various fillers, such as vermiculite, inorganic fibers, quartz sand, micro-glass beads, mica, silicon dioxide, mineral wool, and the like.

Additional additives, such as thickeners and/or rheology additives, as well as fillers, can be added to the composition. Preferably, polyhydroxycarboxylic acid amides, urea derivatives, salts of unsaturated carboxylic acid esters, alkylammonium salts of acidic phosphoric acid derivatives, ketoximes, amine salts of p-toluene sulfonic acid, amine salts of sulfonic acid derivatives, as well as aqueous or organic solutions or mixtures of the compounds used are used as rheology additives, such as anti-settling agents, anti-runoff agents, and thixotropic agents. In addition, rheology additives on the basis of fumed silica or precipitated silicic acids or on the basis of silanated fumed silica or precipitated silicic acids can be used. Preferably, the rheology additive is fumed silica, modified and non-modified phyllosilicates, precipitation silicic acids, cellulose ethers, polysaccharides, PU and acrylate thickeners, urea derivatives, castor oil derivatives, polyamides and fatty acid amides and polyolefins, if they are present in solid form, powdered celluloses and/or suspension agents such as xanthan gum, for example.

The composition according to the invention may be packaged as a two-component or multi-component system, the term multi-component system also including two-component systems. The composition is preferably packaged as a two-component system, in which the individual constituents of the blowing-agent are separated from one another in a reaction-inhibiting manner prior to use of the composition, and the isocyanate compounds are separated from the component B, which is reactive with respect to isocyanate groups, in a reaction-inhibiting manner prior to use of the composition according to the invention.

The further constituents of the composition are divided up in accordance with their compatibility with one another and with the compounds contained in the composition, and can be contained in one of the two components or in both components. Furthermore, the division of the further constituents, in particular of the solid constituents, can depend on the amounts in which these are intended to be contained in the composition. By means of a corresponding division, a higher fraction, based on the total composition, can occur in some cases. In this case, the fire-protection additive forming the insulation layer can be contained as a total mixture or divided up into individual components, in one component or multiple components. The division takes place depending on the compatibility of the compounds contained in the composition, such that neither a reaction of the compounds contained in the composition with one another or reciprocal disruption, nor a reaction of these compounds with the compounds of the other constituents can take place. This is dependent on the compounds used.

The present invention also relates to a fire-protection profile produced from the multi-component composition according to the invention. The fire-protection profiles according to the invention are produced by mixing the components of the multi-component composition according to the invention. The reaction of the components results in foaming.

The fire-protection profiles according to the invention are preferably produced in continuous production, in which the fire-protection profiles are separated to the desired length at the end. In order to provide the fire-protection profile with the desired shape, support elements resting on all sides can be used during foaming.

The fire-protection profile preferably has a rectangular cross section. As a result, the fire-protection profiles can be processed particularly easily and without gaps in a wall or ceiling aperture.

The fire-protection profile pieces can be cut to a length of, for example, 80 cm in order to enable simple handling during packaging and transport. Before installation, the profile pieces can be cut to shorter pieces by a user if necessary.

The present invention furthermore also relates to the use of temperature-regulating fillers in fire-protection profiles, in particular in fire-protection profiles having a low density for improving the fire-resistance duration. The fire-protection profiles preferably have a density between 100 kg/m³ and 200 kg/m³ in the cured state. Preferably, the fire-protection profile comprises polyurethane and/or polyurea as a binder. If applicable, all above statements apply in these cases.

The invention is explained in greater detail in the following with reference to a number of examples. All examples and drawings support the scope of the claims. However, the invention is not limited to the specific embodiments shown in the examples and drawings.

### EMBODIMENTS

Unless stated otherwise, all constituents of the compositions that are listed here are commercially available and were used in the usual commercial quality.

Unless stated otherwise, all % data given in the examples relate to the total weight of the composition described, as a calculation basis.

List of the Constituents Used in the Examples and References (Explanation of Abbreviations) as Well as their Trade Names and Sources of Supply:

TABLE 1
Composition of the constituents used in the examples

| | Description |
|---|---|
| Desmophen 5168 T | Polypropylene ether polyol (Covestro) |
| Water | H₂O (tap water) |
| Dabco 33 LV | Oxydipropanol 67% + 1,4-diazabicyclooctane |
| | 33% (Evonik) |
| Jeffcat ZF 10 | 2-(2-/2-dimethylaminoethoxy)-ethylmethylamino) |
| | ethanol (Huntsman) |
| Kropfmühl | Expandable graphite (Kropfmühl) |
| ES 700 FS pH | |
| Desmodur 44V20L | Methylenediphenyl isocyanates (Covestro) |
| Casul H1i | Ettringite having the structural formula |
| | 3 Ca•Al₂O₃•3 CaSO₄•32 H₂O (Ettringite) |
| | (Remondis Production GmbH); |
| | water of crystallization fraction 45% |
| Pural MG 70 | Aluminum magnesium hydroxycarbonate having a |
| | 70:30 ratio of MgO:Al2O3 (Sasol) |
| Specialty brick | Brick dust having a particle size of ≤ 3 mm (Peter |
| dust 0-3 mm | Stadler GmbH) |
| Aerogel | Aerogel based on silicate (Cabot) |
| particles P100 | |

TABLE 2
Composition of the reference example and of examples 1 to 8 according to the invention [wt. %]

| | | | Example | Example | Example | Example | Example | Example | Example | Example |
|---|---|---|---|---|---|---|---|---|---|---|
| | | Reference | 1 | 2 | 3 | 4 | 5 | 6 | 7 | 8 |
| Component | Desmophen | 67.89 | 67.2 | 67.2 | 67.2 | 67.89 | 33.64 | 33.64 | 33.64 | 33.64 |
| B, | 5168 T | | | | | | | | | |
| reactive | Water | 1.36 | 1.34 | 1.34 | 1.34 | 1.36 | 0.673 | 0.673 | 0.673 | 0.673 |
| with | Dabco 33 LV | 0.815 | 0.806 | 0.806 | 0.806 | 0.815 | 0.404 | 0.404 | 0.404 | 0.404 |
| respect to | Jeffcat ZF 10 | 0.407 | 0.403 | 0.403 | 0.403 | 0.407 | 0.202 | 0.202 | 0.202 | 0.202 |
| isocyanate | Kropfmühl | 6.79 | 6.72 | 6.72 | 6.72 | 6.79 | 3.36 | 3.36 | 3.36 | 3.36 |
| groups | ES 700 FS | | | | | | | | | |
| | pH | | | | | | | | | |
| | Casul H1i | — | 1 | — | — | — | 50 | — | — | — |
| | Pural MG 70 | — | — | 7 | — | — | — | 50 | — | — |
| | Brick powder | — | — | — | 1 | — | — | — | 70 | — |
| | Aerogel | — | — | — | — | 7 [ml] | — | — | — | 100 [ml] |
| | granulate | | | | | | | | | |
| Isocyanate | Desmodur | 22.74 | 22.51 | 22.51 | 22.51 | 22.74 | 11.72 | 11.72 | 11.72 | 11.72 |
| component | 44V20L | | | | | | | | | |
| A | | | | | | | | | | |

Preparation of the Component B, Reactive with Respect to Isocyanate Groups

In a beaker, the polyol is first provided, and then water and the catalysts are added. The mixture is stirred with a spatula for 20 seconds until a homogeneous liquid is formed. Subsequently, the expanding expandable graphite is added and the mixture is stirred until a homogeneous mass is produced. Subsequently, the endothermic fillers and/or the fillers having low heat capacity are added and the composition is again stirred until homogeneous.

### Production of a Beaker Foam

In order to produce a beaker foam, 100 g of foam formulation is prepared in a beaker having a volume of 580 ml. For this purpose, the isocyanate component A is added to component B and stirred for 5 seconds with rapid stirring movement. It is then a waiting period until the foam has reached its full height and has cured. The end of the reaction is achieved when the foam is no longer sticky, usually after 40 seconds.

### Clay Furnace Test

In order to carry out what is known as a clay furnace test, an aerated concrete block of dimensions 300×300×70 mm³ (W×L×H) is prepared. In this, four holes of diameter of 8 cm each are prepared using a holesaw, such that they have a volume of 140.7 ml. The block is placed on a flat surface such that the cylindrical holes are delimited towards the bottom. In a beaker, component B and the isocyanate component A are mixed according to Table 2, stirred for about 5 seconds and poured directly into one of the holes. Subsequently, the hole is closed from above by a weight of at least 1 kg, such that the foam cannot foam out beyond the cylinder mold. After about 40 seconds, the weight can be removed. The resulting foam should completely fill the cylinder and have a density of 130 g/L. After filling of all openings, the block is placed in the opening, provided for this purpose, of a gas top loader pot burner G80 from Rhode. The heat transfer to the non-fire side can thus be measured. Thermocouples are attached centrally on the foam cylinders, on the outer side. A predefined temperature program is then started. The gas flame required for this is started and the furnace heats up from room temperature to a temperature of 650° C. in the first 10 minutes. Over the next 50 minutes, the temperature continues to increase until it reaches approximately a value of 950° C. after 1 hour. For evaluation, the temperature values of the thermocouples after 60 minutes are used, and evaluated relative to the reference. The results are shown in the table below (for the compositions see Table 2 above):

TABLE 3
Results of the clay furnace test

| | Temperature | [%] Temperature |
|---|---|---|
| | after 60 | in relation |
| Formulation | min [° C.] | to reference |
| Reference | 294.3 | 100 |
| Example 1 (1 wt. % Casul H1i) | 197.8 | 67 |
| Example 2 (7 wt. % Pural MG 70) | 199.8 | 68 |
| Example 3 (1 wt. % brick dust) | 241.7 | 82 |
| Example 4 (7 ml aerogel) | 160.3 | 54 |

### Thermogravimetric Analysis (TGA) of the Fillers

For the thermogravimetric analysis, the filler to be measured is weighed into a sample crucible with the aid of a spatula in an amount of about 50 mg. Subsequently, the sample is placed in a TGA/DSC3+ instrument from Mettler Toledo. The sample is heated at a heating rate of 10 K/min in a temperature range of 30° C. to 1100° C. in an air atmosphere. The weight loss of the sample is recorded in the course of the heating program.

The onset temperatures of the temperature-regulating fillers shown in the table below were determined by means of thermogravimetric analysis (TGA):

TABLE 4
Determination of the onset temperature by means of TGA analysis

| Temperature-regulating filler | Onset temperature (TGA) |
|---|---|
| Casul H1i | 96° C. |
| Plural MG 70 | 181° C. |

1. A foamable multi-component composition, comprising:
i) at least one isocyanate component A containing at least one polyisocyanate,
ii) at least one component B which is stored separately from the isocyanate component A in a reaction-inhibiting manner and is reactive with respect to isocyanate groups, containing at least one compound selected from the group consisting of compounds having at least two amino groups, polyols and combinations thereof,
iii) at least one fire-protection additive that forms an insulation layer, and
iv) a blowing agent comprising one or more compounds capable of releasing CO₂ by reaction, the individual constituents of the blowing agent being separated from one another in a reaction-inhibiting manner before the multicomponent composition is used, wherein the isocyanate component A and/or the component B which is reactive with respect to isocyanate groups comprises at least one temperature-regulating filler.

2. The foamable multi-component composition according to claim 1, wherein the temperature-regulating filler is selected from the group consisting of endothermic fillers, fillers having a thermal conductivity of <1 W m⁻¹ K⁻¹, and mixtures thereof.

3. The foamable multi-component composition according to claim 2, wherein the temperature-regulating filler is an endothermic filler and the endothermic reaction of the endothermic filler begins in a temperature range of 70° C. to 300° C.

4. The foamable multi-component composition according to claim 2, wherein the endothermic filler contains at least one crystalline or semi-crystalline inorganic compound comprising hydration water.

5. The foamable multi-component composition according to claim 4, wherein the crystalline or semi-crystalline inorganic compound comprising hydration water is selected from the group consisting of ettringites, layered double hydroxides (LDH) and mixtures thereof.

6. The foamable multicomponent composition according to claim 2, wherein the temperature-regulating filler is a filler having a thermal conductivity <1 W m⁻¹K⁻¹ and is selected from the group consisting of brick dust, aerogels, and mixtures thereof.

7. The foamable multi-component composition according to claim 1, wherein a weight percentage fraction of the temperature-regulating filler is in a range from 1 to 70 wt. %, based on a total weight of the foamable multi-component composition.

8. The foamable multi-component composition according to claim 3, wherein the multi-component composition comprises both an endothermic filler and a filler having a thermal conductivity <1 W m⁻¹K⁻¹.

9. The foamable multi-component composition according to claim 8, wherein the endothermic filler and the filler having a thermal conductivity <1 W m⁻¹K⁻¹ are used in a weight percentage ratio of 1:1.

10. The foamable multi-component composition according to claim 1, wherein the blowing agent comprises water.

11. The foamable multi-component composition according to claim 1, wherein the fire-protection additive that forms an insulation layer is selected from the group consisting of graphite intercalation compounds, expandable silicate material and combinations thereof.

12. A fire-protection profile produced from the foamable multi-component composition according to claim 1.

13. The fire-protection profile according to claim 12, wherein the fire-protection profile has a density between 100 kg/m³ and 200 kg/m³ in a cured state.

14. Use A method of improving fire-resistance duration of a fire-resistance profile in event of a fire, the method comprising: adding at least one temperature-regulating filler in a fire-protection profile having a low density.

15. The method according to claim 14, wherein the fire-protection profile comprises a polyurethane foam and/or a polyurea foam.
